(19) United States
(12) Patent Application Publication
(10) Pub. No.: US 2009/0065569 A1
(43) Pub. Date: Mar. 12, 2009

(54) PROGRESS DISPLAY APPARATUS AND PROGRESS MANAGEMENT SYSTEM

(75) Inventors: Tomoaki SHIBATA, Nagoya-shi (JP); Yasuhisa ICHIKAWA, Nagoya-shi (JP); Kazuya NISHIMURA, Suzuka-shi (JP); Shiro YAMADA, Kasugai-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/208,245

(22) Filed: Sep. 10, 2008

(30) Foreign Application Priority Data
Sep. 12, 2007 (JP) 2007-236508

(51) Int. Cl. G06F 7/00

(52) U.S. Cl. 235/376

(57) ABSTRACT

This disclosure discloses a progress display apparatus displaying a progress state of an event by a plurality of work procedures along a chronological order, comprising: a display signal output portion for a total procedure configured to output a display signal for displaying a total-procedure display part corresponding to all the procedures of the plurality of work procedures to be completed; and a display signal output portion for a completed procedure configured to output a display signal for displaying a completed-procedure display part corresponding to at least one work procedure having been completed so far among the plurality of work procedures.

### CROSS-REFERENCE TO RELATED APPLICATIONS

This application claims priority from JP 2007-236508, filed Sep. 12, 2007, the contents of which are hereby incorporated by reference.

### BACKGROUND OF THE INVENTION

1. Field of the Invention

The present invention relates to a progress display apparatus displaying a progress state of an event to be completed by a plurality of work procedures along a chronological order and to a progress management system provided therewith.

2. Description of the Related Art

Recently, a RFID (Radio Frequency Identification) system that performs information reading/writing in a non-contact manner between a small-sized RFID tag having a RFID circuit element provided with an IC circuit part storing predetermined RFID tag information and an antenna connected to the IC circuit part and performing information transmission/reception and a reader (reading apparatus)/writer (writing apparatus) has been proposed and is being put into practice in various fields.

As a prior art of the RFID system, the one described in JP, A, 2004-152258, for example, is known. In this prior art, a RFID label (RFID tag) is attached to a document, and tag identification information of the RFID circuit element provided at the RFID tag (tag identifier) and document information are stored in association in a database. Moreover, a plurality of readers (sensors) is provided in the vicinity of a region of a work flow and locations of the readers are also registered in the database in advance. By this arrangement, when the tag identification information of the RFID label attached to the document is read out by the reader, the tag identification information, document information and location are associated, and the location of the document can be grasped. In this way, physical movement of the document is made traceable.

In progress of business operations in general, a plurality of work procedures progresses in parallel. Therefore, in order to effectively manage the business operations, it is necessary to manage progress states of the plurality of work procedures in a centralized manner. At this time, in the above prior art system, it is possible to trace physical movement of the document prepared as the business operation progresses, but even if the work procedure progresses by the movement of the document, the progress state can not be grasped easily in stages.

### SUMMARY OF THE INVENTION

The present invention has an object to provide a progress display apparatus and a progress management system with which progress states of a plurality of work procedures can be grasped easily in stages.

### BRIEF DESCRIPTION OF THE DRAWING

FIG. 1 is a system block diagram illustrating a patent progress management system provided with an apparatus for producing RFID labels of the present embodiment.

FIG. 2 is a system block diagram illustrating a system configuration of the patent progress management system.

FIG. 3 is a block diagram illustrating a detailed configuration of the apparatus for producing RFID labels.

FIG. 4 is a functional block diagram illustrating a functional configuration of a RFID circuit element.

FIG. 5 is a flowchart illustrating a control procedure executed by a control circuit of a server.

FIG. 6 is a flowchart illustrating a detailed procedure of a label issuance processing.

FIG. 7 is a flowchart illustrating a detailed procedure of a main RFID label issuance processing.

FIGS. 8A and 8B are diagrams conceptually illustrating data contents stored in a database.

FIG. 9 is a flowchart illustrating a detailed procedure of a sub RFID label issuance processing.

FIG. 10 is a flowchart illustrating a control procedure executed by a control circuit of the apparatus for producing RFID labels.

FIGS. 11A to 11C are top views illustrating an example of appearances of a main RFID label and a sub RFID label produced by the apparatus for producing RFID labels.

FIG. 12 is a flowchart illustrating a detailed procedure of a progress update processing.

FIG. 13 is a flowchart illustrating a detailed procedure of a progress list display processing.

FIG. 14 is a flowchart illustrating a control procedure executed by a control circuit of a PC at the progress list display.

FIG. 15 is a diagram illustrating an example of the progress list display displayed on a display part of the PC.

FIG. 16 is a flowchart illustrating a detailed procedure of a real search processing.

FIG. 17 is a flowchart illustrating a detailed procedure of a label copy processing.

FIGS. 18A to 18D are diagrams illustrating variations of a progress graph constituted by a total-procedure display part and a completed-procedure display part.

FIG. 19 is a flowchart illustrating a control procedure executed by the control circuit of the PC when the progress list display is made in a variation in which those having reached completion deadlines are displayed in a display mode different from the other procedures.

FIG. 20 is a diagram illustrating an example of the progress list display displayed on a display part of the PC in a variation in which those having reached completion deadlines are displayed in a display mode different from the other procedures.

FIG. 21 is a flowchart illustrating a control procedure executed by the control circuit of the PC in a variation in which those corresponding to a selection instruction input of an operator is extracted from the patent progress list display and selectively displayed.

FIGS. 22A to 22C are diagrams illustrating an example of extraction of the progress list display in a variation in which those corresponding to a selection instruction input of an operator is extracted from the patent progress list display and selectively displayed.

### DETAILED DESCRIPTION OF THE PREFERRED EMBODIMENTS

An embodiment of the present invention will be described referring to the attached drawings. This embodiment is an example in which a document-processing progress management system of the present invention is applied to a patent progress management system that manages patent progress.

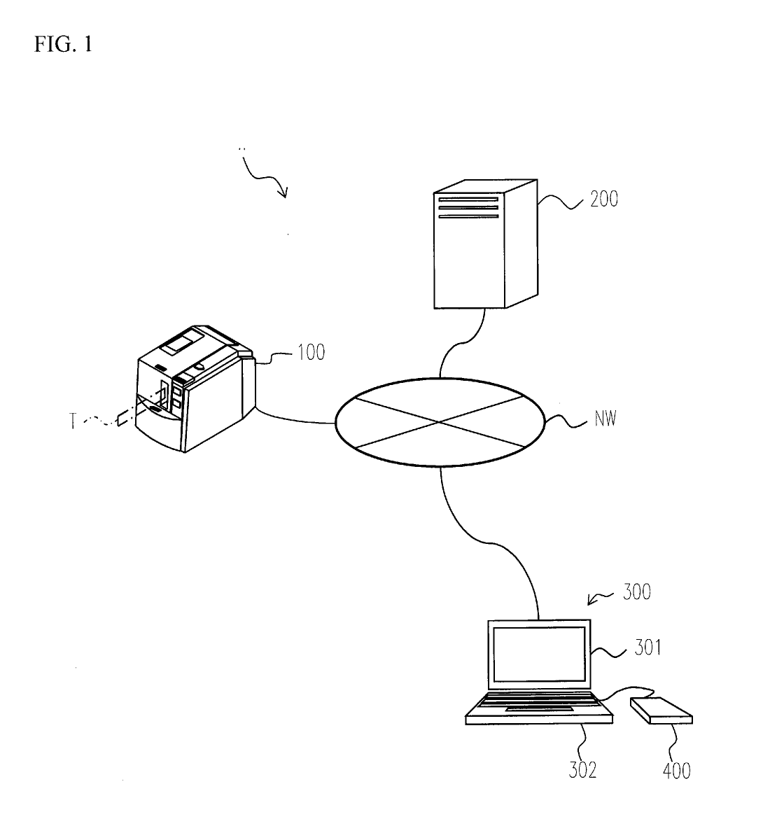

FIG. 1 is a system block diagram illustrating the patent progress management system provided with an apparatus for producing RFID labels of this embodiment.

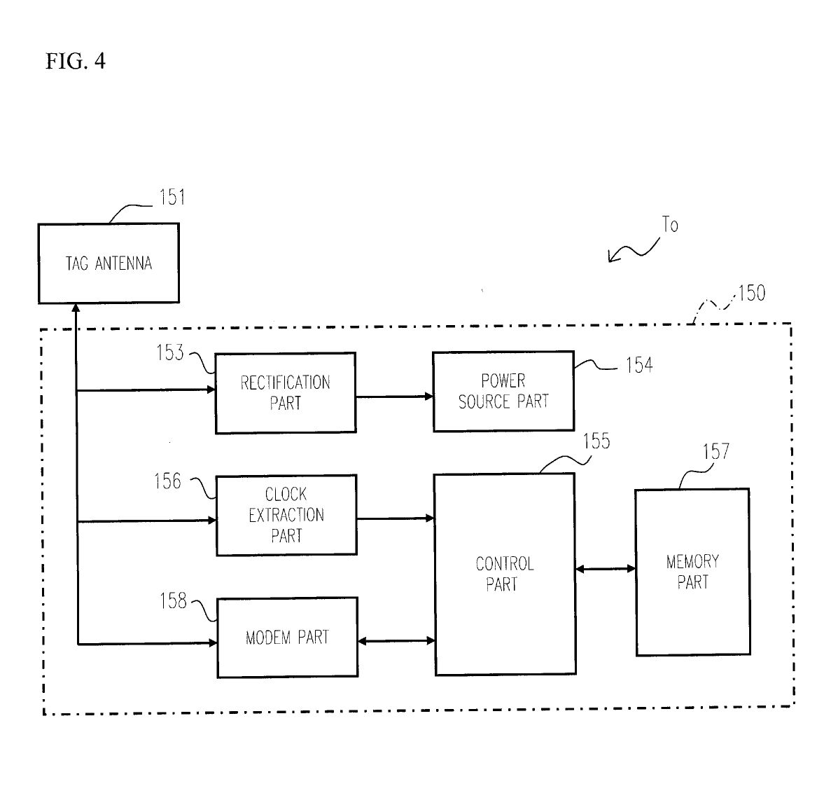

This patent progress management system PS shown in FIG. 1 has an apparatus 100 for producing RFID labels configured to produce a RFID label T having a RFID circuit element To (See FIG. 4, which will be described later) constituted by a tag antenna 151 configured to transmit/receive RFID tag information and an IC circuit part 150 connected thereto and capable of storing the RFID tag information, a server 200 and a personal computer (PC) 300 connected to the apparatus 100 for producing RFID labels in a wired or wireless manner through a communication line NW, and a reader 400 connected to the PC 300 and configured to read out the RFID tag information from the IC circuit part 150 of the RFID circuit element To through radio communication with the produced RFID label T. The PC 300 has a display part 301 such as a liquid crystal display and the like and an operation part 302 such as a keyboard, a mouse and the like so that an operator can view information through the display part 301 or input information using the operation part 302 at each work procedure, which will be described later. Here, only one unit of the PC 300 is shown for simplicity but a plurality of PCs 300 is connected to the communication line NW in actuality so that the operator of each PC 300 can share the server 200 and the apparatus 100 for producing RFID labels.

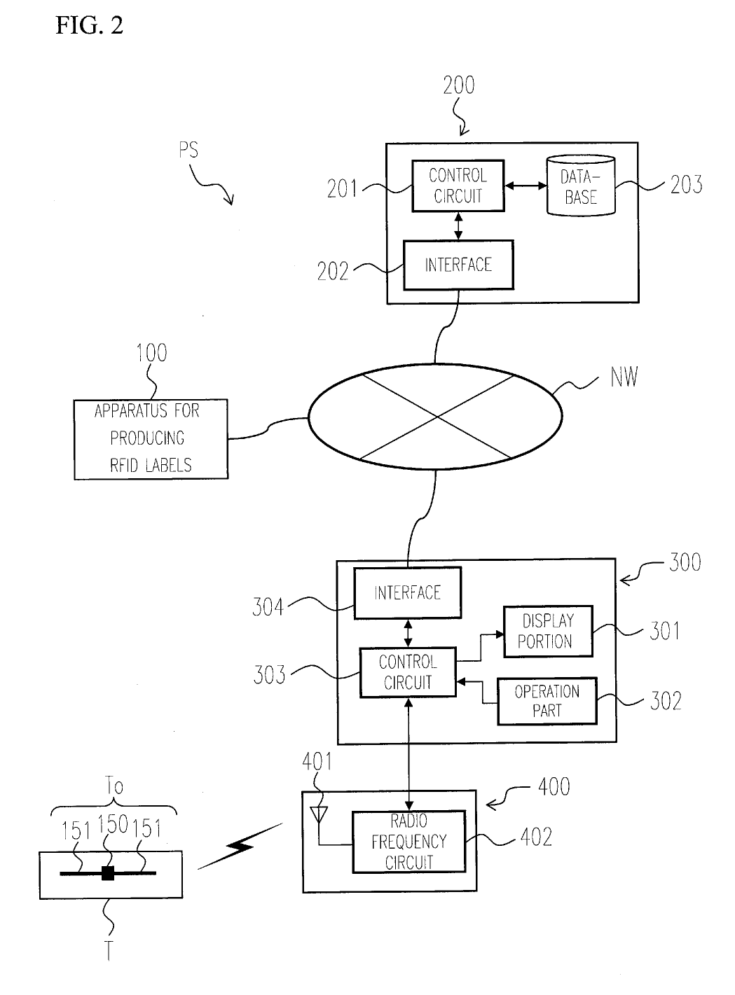

FIG. 2 is a system block diagram illustrating system configuration of the patent progress management system PS. Arrows shown in the figure are an example of a flow of a signal and do not limit the flow direction of the signal.

The server 200 has a control circuit 201 configured to carry out control of the entire server 200, an interface 202 configured to carry out network communication through the communication line NW between the control circuit 201 and the apparatus 100 for producing RFID labels as well as the PC 300, and a database 203 (constituted by a hard disk and the like) in which case information (title of the invention, representative inventor and the like) and progress information of each patent case, information such as a tag ID (tag identification information) of the RFID circuit element To associated with them and the like are stored.

The PC 300 (progress display unit) has the display part 301 configured to make various displays, the operation part 302 for input of various operations by an operator, a control circuit 303 for input/output of information with a radio frequency circuit 402 of the reader 400 and control of the entire PC 300, and an interface 304 configured to conduct network communication through the communication line NW among the control circuit 303, the apparatus 100 for producing RFID labels, and the control circuit 201 of the server 200.

The reader 400 (radio search device, reading device) has an antenna 401 configured to send/receive a signal by radio communication with the tag antenna 151 of the RFID circuit element To provided at the RFID label T and the radio frequency circuit 402 configured to access the IC circuit part 150 of the RFID circuit element To through the antenna 401 via radio communication and to process a signal read out of the RFID circuit element To. This reader 400 is in a size that can be carried by hand of an operator and is configured capable of movement by being carried by the operator in a predetermined range while being connected to the PC 300.

The PC 300 and the reader 400 constitute the progress management system described in each claim.

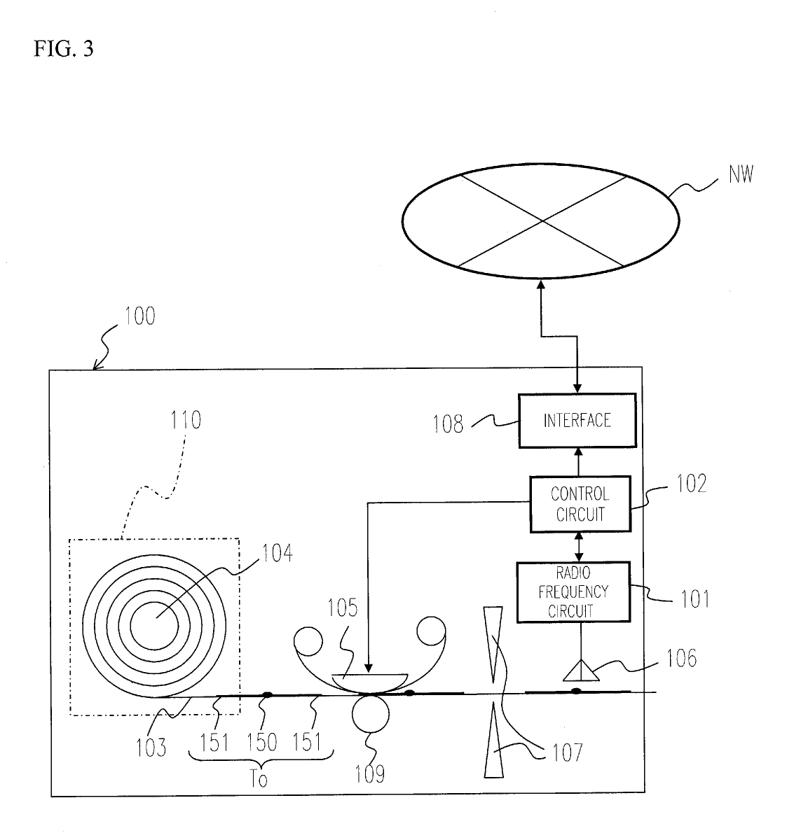

FIG. 3 is a block diagram illustrating detailed configuration of the apparatus 100 for producing RFID labels. The arrows shown in the figure are an example of a flow of a signal and do not limit the flow direction of the signal.

The apparatus 100 for producing RFID labels has a tag-tape roll holder portion 110 to which a roll of tape 104 with RFID tag (it should be in a spiral state originally, but shown in a simplified concentric manner) around which a tag tape 103 (tag medium) provided with the RFID circuit elements To are provided with a predetermined interval is wounded can be detachably attached (or to which a cartridge provided with the roll of tape 104 with RFID tag can be detachably attached), a print head 105 (printing device) configured to apply desired print in a region corresponding to the RFID circuit element To in the tag tape 103 fed out of the roll of tape 104 with RFID tag, an antenna 106 configured to transmit/receive information by radio communication with the RFID circuit element To, a radio frequency circuit 101, a control circuit 102, an interface 108 configured to conduct network communication carried out through the communication line NW with the server 200 and the PC 300, a cutter 107 configured to cut the tag tape 103 for which the print on the tag tape 103 and the information writing on the RFID circuit element To have been completed to a predetermined length to have the RFID label T, and a feeding device (feeding device) 109 provided opposite the print head 105 and controlled by the control circuit 102 and configured to feed the tag tape 103.

The radio frequency circuit 101 and the control circuit 102 generate access information to the IC circuit part 150 of the RFID circuit element To, transmit it to the RFID circuit element To through the antenna 106, and write the information in the IC circuit part 150 of the RFID circuit element To. The radio frequency circuit 101 and the antenna 106 constitute a tag access device configured to make an access to the RFID circuit element by radio communication described in each claim.

The control circuit 102 of the apparatus for producing RFID labels, the control circuit 201 of the server 200, and the control circuit 303 of the PC 300 are so-called microcomputers, though not particularly shown, and comprise CPU, which is a central processing unit, ROM, RAM and the like and execute a predetermined processing procedure according to a program stored in the ROM in advance using a temporary memory function of the RAM.

FIG. 4 is a functional block diagram illustrating functional configuration of the RFID circuit element To. The arrows shown in the figure are an example of a flow of a signal and do not limit the flow direction of the signal.

In FIG. 4, the RFID circuit element To has the tag antenna 151 configured to transmit/receive a signal contactlessly by radio communication with the device antenna (antenna 106 of the apparatus 100 for producing RFID labels and the antenna 401 of the reader 400) and the IC circuit part 150 connected to this tag antenna 151.

The IC circuit part 150 has a rectification part 153 configured to rectify an interrogation wave received by the tag antenna 151, a power source part 154 configured to accumulate energy of the interrogation wave rectified by the rectification part 153 so as to make it a driving power source, a clock extraction part 156 configured to extract a clock signal from the interrogation wave received by the tag antenna 151 and to supply it to a control part 155, a memory part 157 that can store predetermined information signals, a modem part 158 connected to the tag antenna 151, and the control part 155 configured to control operation of the RFID circuit element To through the rectification part 153, the clock extraction part 156, the modem part 158 and the like.

The modem part 158 demodulates a communication signal from the device antenna received by the tag antenna 151 and modulates a reply signal from the control part 155 and transmits it from the tag antenna 151 as a response wave.

The control part 155 executes basic control such as interpretation of a received signal demodulated by the modem part 158, generation of a reply signal based on the information signal stored in the memory part 157, reply of it by the modem part 158 and the like.

The clock extraction part 156 extracts a clock component from the received signal and extracts it to the control part 155 and supplies the clock corresponding to a frequency of the clock component of the received signal to the control part 155.

FIG. 5 is a flowchart illustrating a control procedure executed by the control circuit 201 of the server 200.

First, at Step S10, the control circuit 201 determines whether or not a selection input of a work mode is made by an operator. The work mode here refers to a “label issuance” mode in which a RFID label T is to be produced, a “progress update” mode in which a work process (work procedure) is advanced, a “progress list display” mode in which the progress is displayed, a “real search” mode in which a desired case folder (RFID label T) is searched, and a “label copy” mode in which a copy of the desired RFID label T is produced. This determination is made based on whether or not the control circuit 201 has received a mode selection signal input by the operator using the operation part 302 of the PC 300 through the communication line NW. The control circuit 201 repeats this step till the selection input of the work mode is made and if the selection input is made, the determination is satisfied, and the routine goes to the subsequent Step S20.

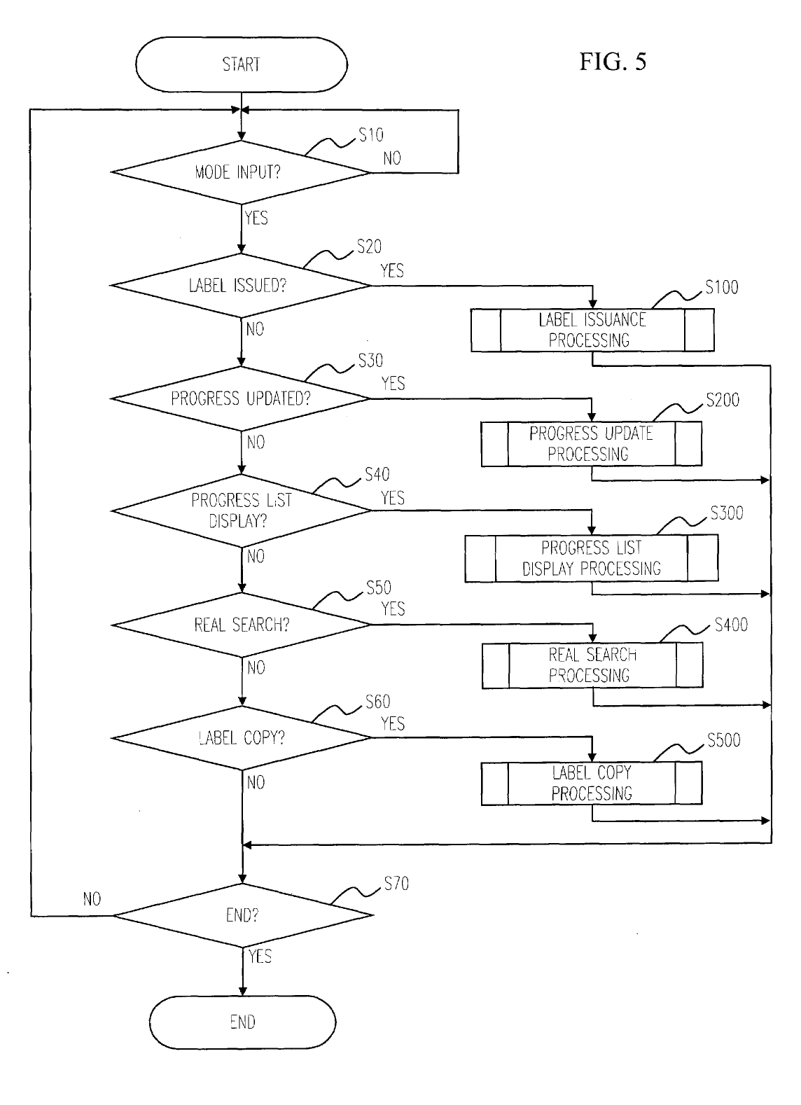

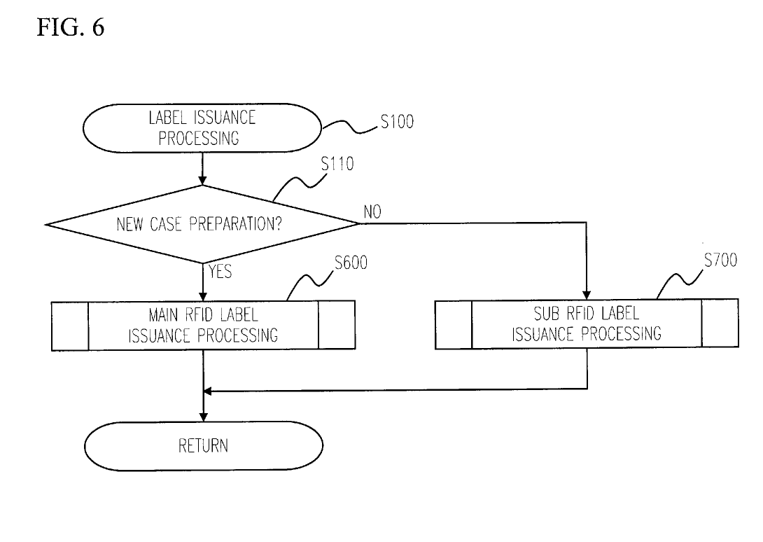

At Step S20, the control circuit 201 determines whether or not the work mode for which the selection input has been made at the above Step S10 is the “label issuance” mode. If the “label issuance” mode has been selected, the determination is satisfied, and the routine goes to Step S100, where label issuance processing configured to produce the RFID label T is carried out (See FIG. 6, which will be described later). After that, the routine goes to Step S70. On the other hand, if the “label issuance” mode has not been selected, the determination is not satisfied, and the routine goes to the subsequent Step S30.

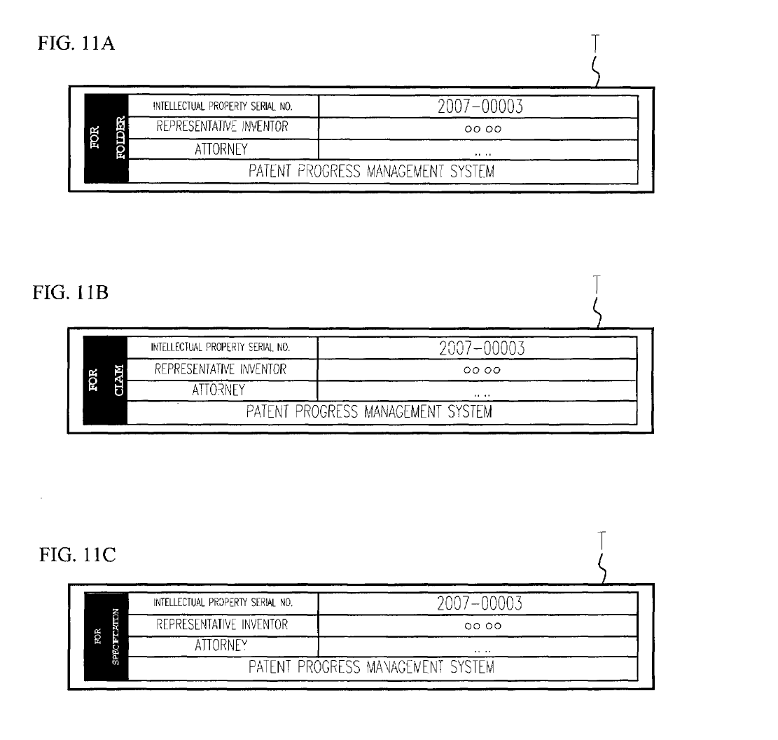

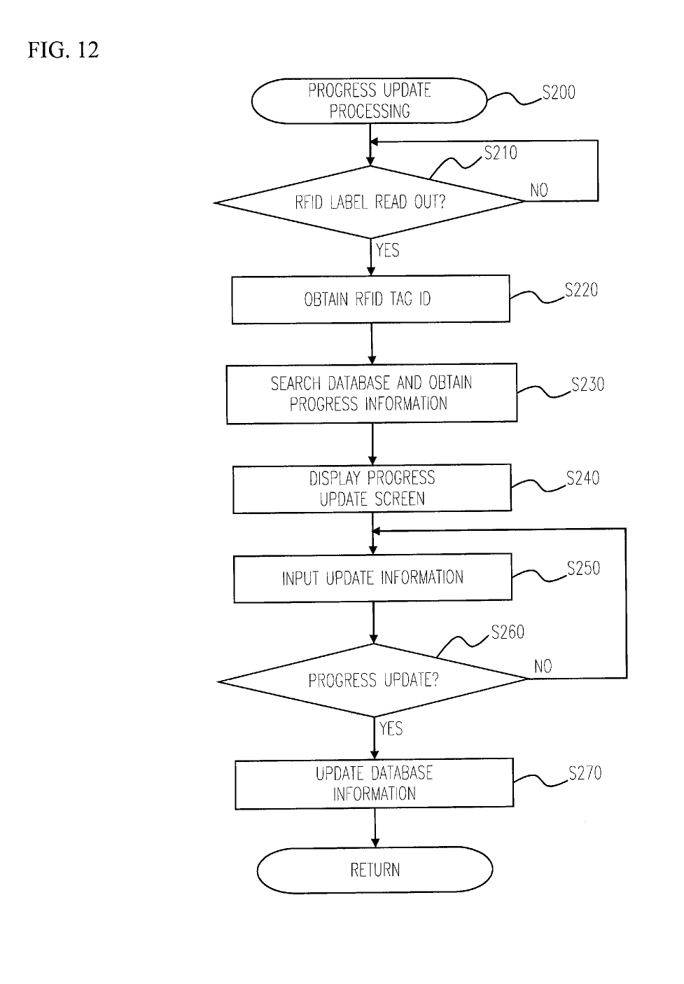

At Step S30, the control circuit 201 determines whether or not the work mode for which the selection input has been made at the above Step S10 is the “progress update” mode. If the “progress update” mode has been selected, the determination is satisfied, and the routine goes to Step S200, where progress update processing configured to progress the work process is carried out (See FIG. 12, which will be described later). After that, the routine goes to Step S70. On the other hand, if the “progress update” mode has not been selected, the determination is not satisfied, and the routine goes to the subsequent Step S40.

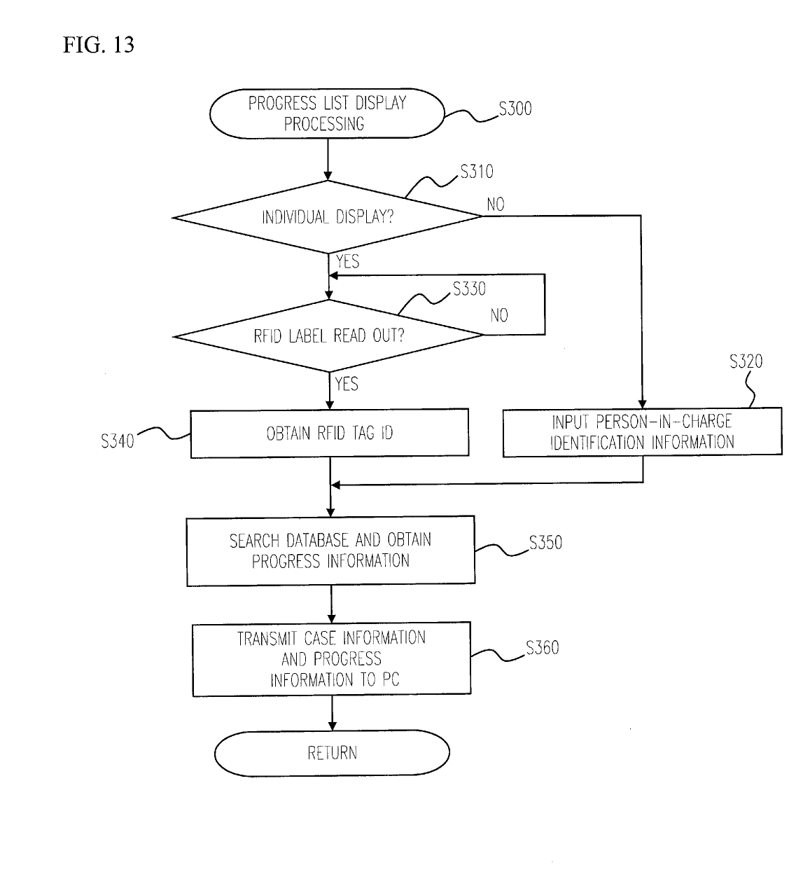

At Step S40, the control circuit 201 determines whether or not the work mode for which the selection input has been made at the above Step S10 is the “progress list display” mode. If the “progress list display” mode has been selected, the determination is satisfied, and the routine goes to Step S300, where progress list display processing configured to transmit progress information and the like so that the PC 300 carries out the progress list display is carried out (See FIG. 13, which will be described later). After that, the routine goes to Step S70. On the other hand, if the “progress list display” mode has not been selected, the determination is not satisfied, and the routine goes to the subsequent Step S50.

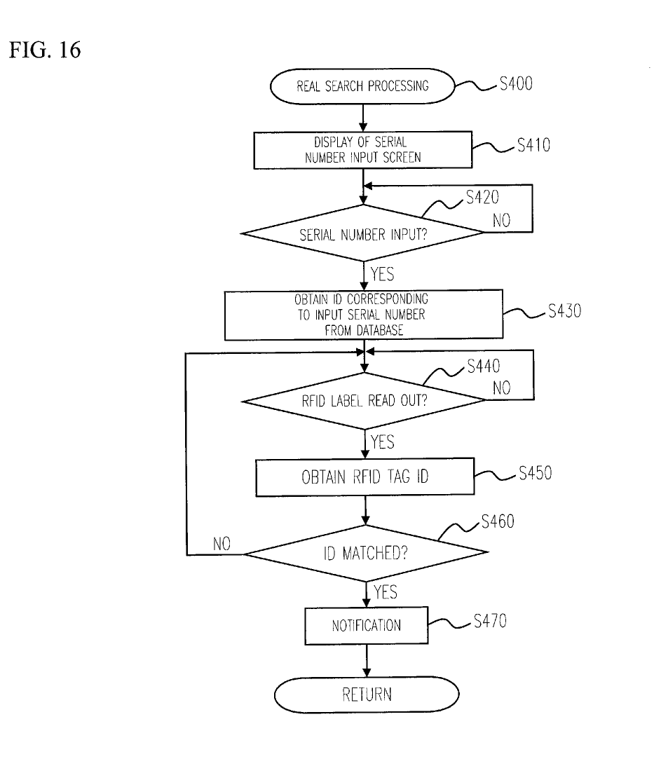

At Step S50, the control circuit 201 determines whether or not the work mode for which the selection input has been made at the above Step S10 is the “real search” mode. If the “real search” mode has been selected, the determination is satisfied, and the routine goes to Step S400, where real search processing configured to search the desired RFID label T using the reader 400 connected to the PC 300 is carried out (See FIG. 16, which will be described later). After that, the routine goes to Step S70. On the other hand, if the “real search” mode has not been selected, the determination is not satisfied, and the routine goes to the subsequent Step S60.

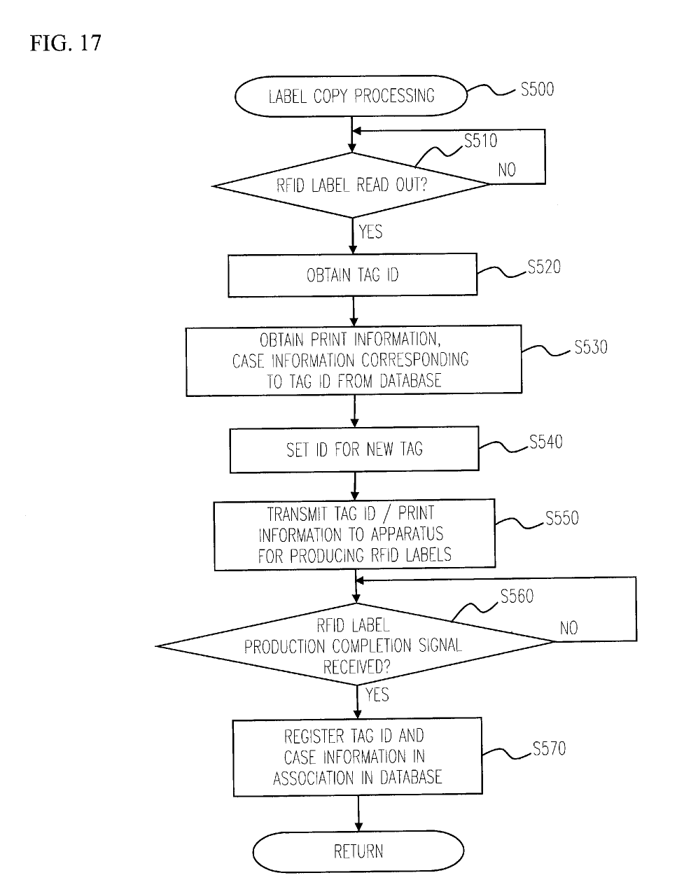

At Step S60, the control circuit 201 determines whether or not the work mode for which the selection input has been made at the above Step S10 is the “label copy” mode. If the “label copy” mode has been selected, the determination is satisfied, and the routine goes to Step S500, where label copy processing configured to produce a copy of the desired RFID label T by the apparatus 100 for producing RFID labels is carried out (See FIG. 17, which will be described later). After that, the routine goes to Step S70. On the other hand, if the “label copy” mode has not been selected, the determination is not satisfied, and the routine goes to the subsequent Step S70.

At Step S70, the control circuit 201 determines whether or not the work is to be finished. Specifically, when the operator closes the software configured to carry out the above works in the PC 300 or powers off the PC 300, it is determined as work finished. In the other cases, the determination is not satisfied but the routine returns to the preceding Step S10. On the other hand, if the work finish operation as above is carried out, the determination is satisfied, and this flow is finished.

The flowchart does not limit the present invention to the procedures shown in the flow but is capable of addition/deletion of procedures or change of the order and the like in a range not departing from the gist and technical idea of the invention.

FIG. 6 is a flowchart illustrating a detailed procedure of the label issuance processing.

First, at Step S110, the control circuit 201 determines whether or not the RFID label T to be issued corresponds to a new case. This determination is made based on whether or not the control circuit 201 has received an input signal indicating the new case input by the operator using the operation part 302 of the PC 300 (input by pushing a “new registration” button displayed on a screen, for example) through the communication line NW. If the input signal has been received (if it is new registration), the determination is satisfied, and the routine goes to the subsequent Step S600.

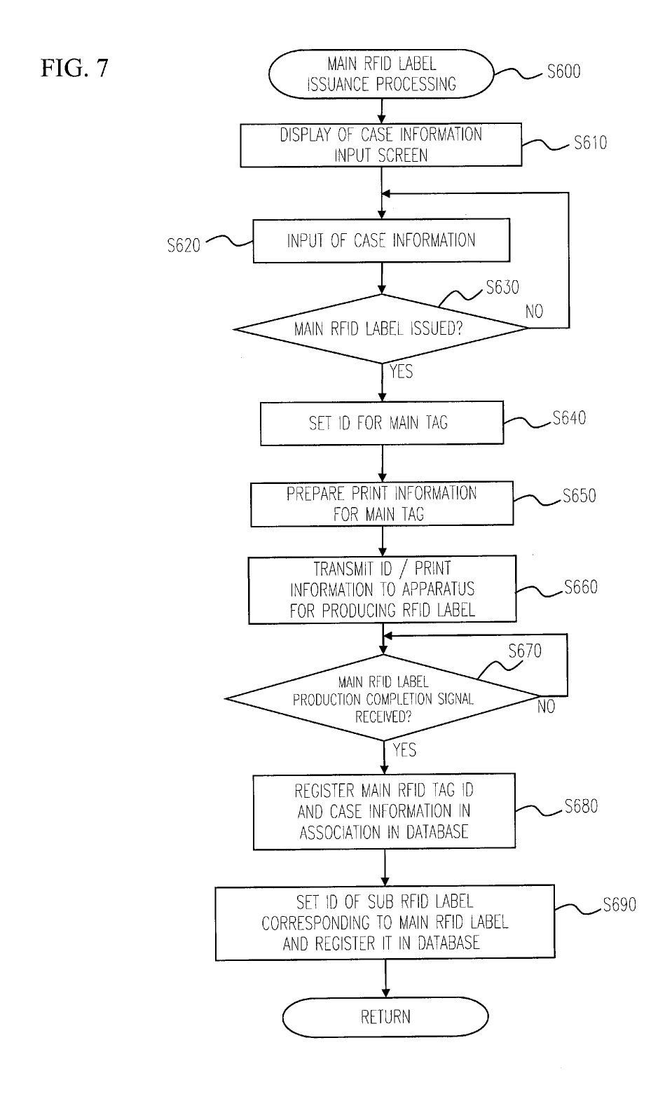

At Step S600, the control circuit 201 executes main RFID label issuance processing configured to produce first RFID label T (hereinafter described as “main RFID label T”) at registration of the new case (See FIG. 7, which will be described later). The main RFID label T is used by being attached to a folder corresponding to each patent case. The folder stores various documents (orders, claims, specification manuscripts and the like) of the corresponding patent case (file wrapper, for example). Then, this routine is finished.

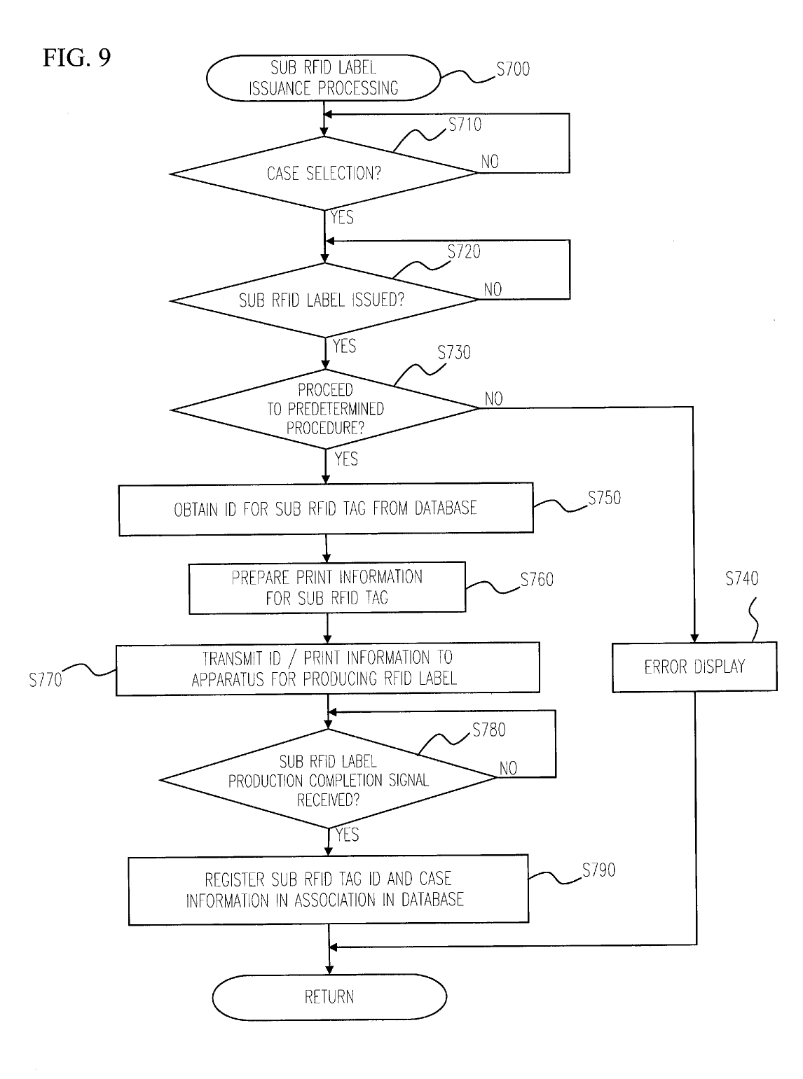

On the other hand, if the input signal has not been received at the above Step S110 (if it is not new registration), the determination is not satisfied and the routine goes to Step S700. At Step S700, the control circuit 201 carries out sub RFID label issuance processing configured to produce the RFID label T whose production is scheduled after the production of the main RFID label T (hereinafter described as “sub RFID label T”) for the case for which the main RFID label T has been already produced (See FIG. 9, which will be described later). In this embodiment, the sub RFID label T is produced when claims (patent claims) are received by a staff in charge of intellectual property from a patent attorney's office for each patent case and when a specification manuscript is received and used by being attached to a claim manuscript and the specification manuscript, respectively. Then, this routine is finished.

The above flowchart does not limit the present invention to the procedures shown in the flow but is capable of addition/deletion of procedures or change of the order and the like in a range not departing from the gist and technical idea of the invention.

FIG. 7 is a flowchart illustrating a detailed procedure of the main RFID label issuance processing.

First, at Step S610, the control circuit 201 transmits a control signal to the control circuit 303 of the PC 300 through the communication line NW and has the display part 301 display a case information input screen. The case information input screen is a screen in which case information is input when a staff in charge of intellectual property newly registers a patent case and has input columns such as intellectual property serial number (application identification information), title of the invention, representative inventor, ordering attorney (patent attorney's office), date of registration and the like.

At the subsequent Step S620, the control circuit 201 inputs the case information input by the staff in charge of intellectual property using the operation part 302 of the PC 300 while referring to the case information input screen through the communication line NW.

At the subsequent Step S630, the control circuit 201 determines whether or not the main RFID label T is to be issued. This determination is made based on whether or not the control circuit 201 has received an issuance command signal input by the staff in charge of intellectual property using the operation part 302 of the PC 300 (input by pushing an “issuance” button displayed on the screen, for example) through the communication line NW. If the issuance command signal has not been received, the determination is not satisfied and the routine returns to the above Step S620. On the other hand, if the issuance command signal has been received, the determination is satisfied and the routine goes to the subsequent Step S640.

At Step S640, the control circuit 201 sets a tag ID (tag identification information) to be written in the RFID circuit element To of the main RFID label T to be produced. This setting is made by reading out by the control circuit 201 of an appropriate ID from a tag ID database stored in the database 203. A database for tag ID setting may be provided separately from the database 203.

At Step S650, the control circuit 201 prepares print information to be printed on the main RFID label T to be produced. In this embodiment, use of the RFID label (“for folder” in the case of the main RFID label T), intellectual property serial number, representative inventor, attorney, and title of the invention are printed on the main RFID label T (See FIG. 11A, which will be described later), and the print information includes these types of information.

At the subsequent Step S660, the control circuit 201 transmits the tag ID set at Step S640 and the print information prepared at Step S650 to the control circuit 102 of the apparatus 100 for producing RFID labels through the communication line NW.

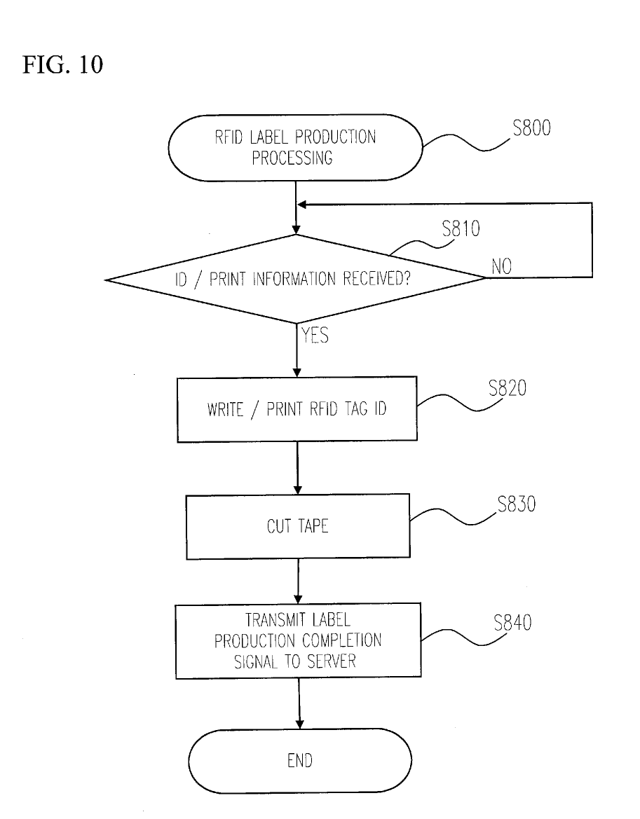

At Step S670, the control circuit 201 determines whether or not a main RFID label production completion signal (See Step S840 in FIG. 10, which will be described later) transmitted from the control circuit 102 when the production of the main RFID label T is completed in the apparatus 100 for producing RFID labels has been received through the communication line NW. This step is repeated till the main RFID label production completion signal is received and upon receipt, the determination is satisfied and the routine goes to the subsequent Step S680.

At Step S680, the control circuit 201 registers the tag ID set at Step S640, the case information input at Step S620, and the print information prepared at Step S650 in association in the database 203.

At the subsequent Step S690, the control circuit 201 sets a tag ID of the sub RFID label T whose production is scheduled after the production of the produced main RFID label T, that is, the tag ID of the two sub RFID labels T for claim and for specification manuscript similarly to Step S640 and registers these tag IDs for the sub RFID labels T (hereinafter described as “sub tag ID” as appropriate) in association with the tag ID for the main RFID label T registered at Step S680 (hereinafter described as “main tag ID” as appropriate) integrally in the database 203. By this arrangement, a storage region for the sub tag ID can be generated in the database 203 in association with the storage region for the main tag ID. Then, this routine is finished.

The flowchart does not limit the present invention to the procedures shown in the flow but is capable of addition/deletion of procedures or change of the order and the like in a range not departing from the gist and technical idea of the invention.

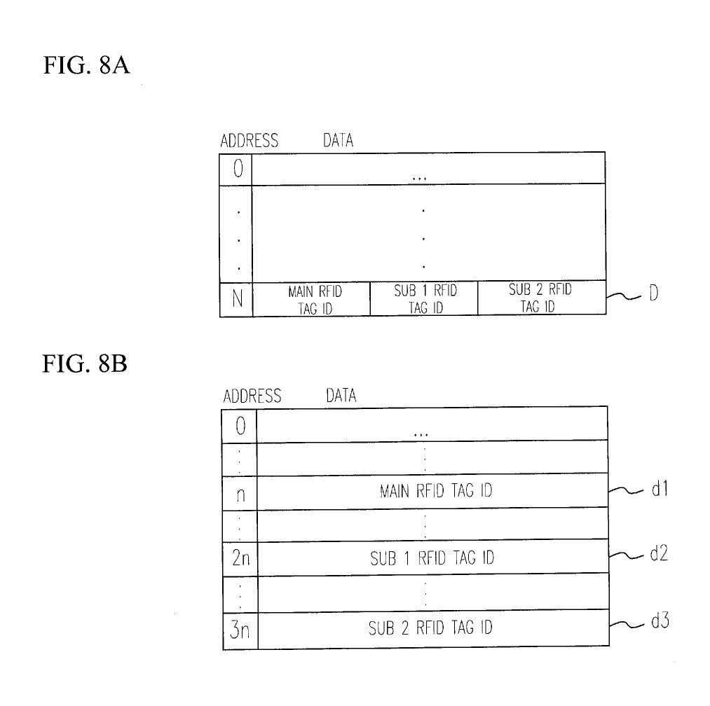

FIG. 8 is a diagram conceptually illustrating data contents (tag ID, here) stored in the database 203 at Step S680 and Step S690.

As shown in FIG. 8, the database 203 is in a form that predetermined data is stored at a predetermined memory block address. The address here indicates a location of the memory block when a memory region of the database 203 (hard disk, for example) is divided into memory regions (memory blocks) by a predetermined memory capacity (several K bytes, for example).

As shown in FIG. 8A, in this embodiment, the main tag ID and the sub tag ID are integrally registered at a memory block D (storage region, integral storage region) of N address in the database 203 in association. Here, a sub 1 tag ID shown in the figure refers to a tag ID of a sub RFID label T for claim and a sub 2 tag ID for a tag ID of a sub RFID label T for specification manuscript.

In the above, the main tag ID and the sub tag ID are integrally stored in the same memory block address, but not limited to that. That is, as shown in FIG. 8B, the main tag ID and the sub tag ID may be stored individually in a plurality of storage regions associated with each other. In an example shown here, the main tag ID is stored in a memory block d1 (storage region, individual storage region) at n address, the sub tag ID for claim in a memory block d2 (storage region, individual storage region) at 2n address, and the sub tag ID for specification manuscript in a memory block d3 (storage region, individual storage region) at 3n address, and association data associating these memory blocks d1, d2, d3 are stored in an appropriate memory block.

By individually storing the main tag ID and the sub tag ID as above, freedom in storage locations or storage modes can be increased as compared with the case of storage in an integral region as above.

FIG. 9 is a flowchart illustrating a detailed procedure of the sub RFID label issuance processing.

First, at Step S710, the control circuit 201 determines whether or not a case to produce the sub RFID label T has been selected from the registered cases. This determination is made based on whether or not the control circuit 201 has received a case selection signal input by the staff in charge of intellectual property using the operation part 302 of the PC 300 (input when a list of registered cases is displayed on the screen and the staff in charge of intellectual property selects a specific case from the list, for example) through the communication line NW or not. This step is repeated till the case selection signal is received, and upon receipt, the determination is satisfied and the routine goes to the subsequent Step S720.

At Step S720, the control circuit 201 determines if the sub RFID label T is to be issued or not. This determination is made based on whether or not the control circuit 201 has received an issuance command signal input by the staff in charge of intellectual property using the operation part 302 of the PC 300 (input by pushing the “issuance” button displayed on the screen, for example) through the communication line NW. This step is repeated till the issuance command signal is received, and upon receipt, the determination is satisfied and the routine goes to the subsequent Step S730.

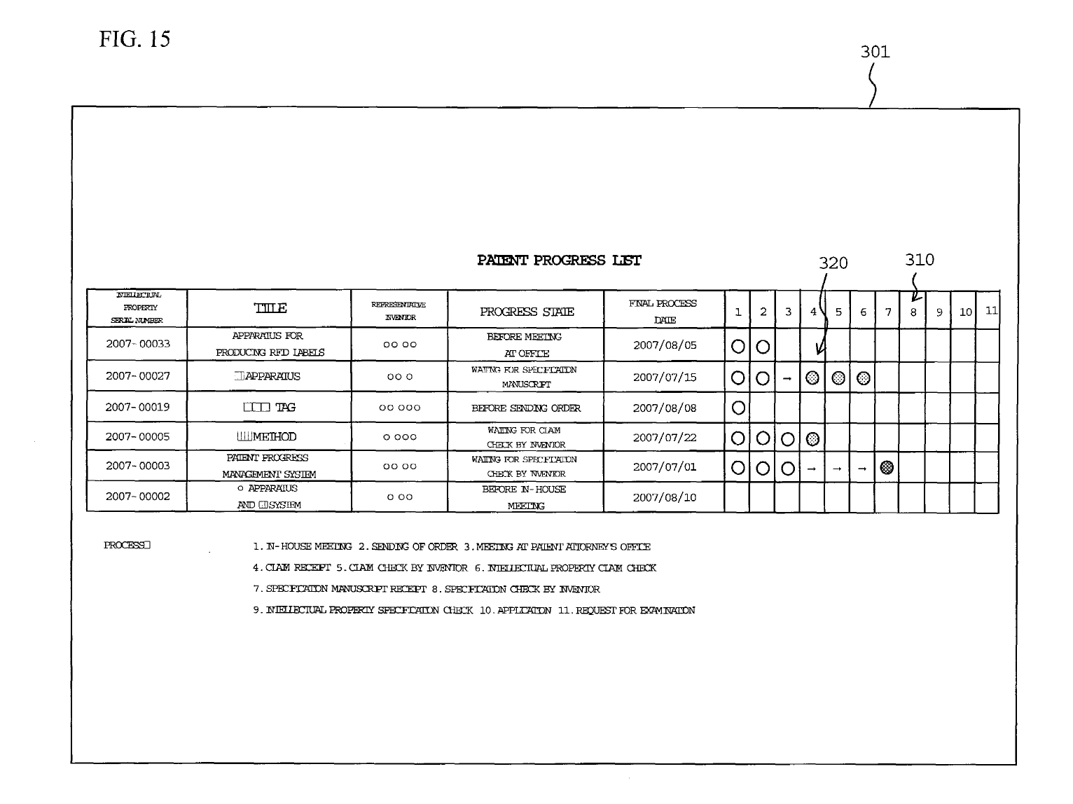

At Step S730, the control circuit 201 determines whether or not the case selected at Step S710 has progressed to a predetermined work process. Specifically, in this embodiment, work processes of each case are constituted by eleven processes of an in-house meeting (process 1), sending of an order (process 2), meeting with a patent attorney's office (process 3), receipt of claims (process 4), claim check by inventor (process 5), intellectual property claim check (process 6), receipt of specification manuscript (process 7), manuscript check by inventor (process 8), intellectual property specification check (process 9), filing (process 10), request for examination (process 11) (See FIG. 15, which will be described later), and it is determined whether or not progress has been made to the claim receipt (process 4) or the specification manuscript receipt (process 7) among them. If the progress has not been made to the claim receipt (process 4) or the specification manuscript receipt (process 7), the determination is not satisfied, the routine returns to Step S740, and a predetermined error display is made on the display part 301 by sending a control signal to the control circuit 303 of the PC 300 (“Claim has not been received yet”, “Specification manuscript has not been received yet”, for example). On the other hand, if the progress has been made to the claim receipt (process 4) or the specification manuscript receipt (process 7), the determination is satisfied and the routine goes to the subsequent Step S750.

At Step S750, the control circuit 201 reads out of the database 203 and obtains the tag ID (tag identification information) to be written in the RFID circuit element To of the sub RFID label T to be produced (if the work process has progressed to the claim receipt (process 4), it is the sub RFID label T for claim, while if the work process has progressed to the specification manuscript receipt (process 7), it is the sub RFID label T for specification manuscript. The same applies to the following) (as mentioned above, these sub tag IDs are set in advance at production of the main RFID label T and stored in a memory block D at an address N of the database 203. See FIG. 8A.)

At the subsequent Step S760, the control circuit 201 prepares the print information to be printed on the sub RFID label T to be produced. In this embodiment, on the sub RFID label T, similar to the above-mentioned main RFID label T, usage of the RFID label (in the case of the sub RFID label T, “for claim” or “for specification”), intellectual property serial number, representative inventor, attorney, and title of the invention are printed (See FIGS. 11B and 11C, which will be described later), and the print information includes these types of information.

At the subsequent Step S770, the control circuit 201 transmits the tag ID obtained at Step S750 and the print information prepared at Step S760 to the control circuit 102 of the apparatus 100 for producing RFID labels through the communication line NW.

At Step S780, the control circuit 201 determines whether or not a sub RFID label production completion signal transmitted from the control circuit 102 when the production of the sub RFID label T is completed in the apparatus 100 for producing RFID labels (See step S840 in FIG. 10, which will be described later) has been received through the communication line NW. This step is repeated till the sub RFID label production completion signal is received, and upon receipt, the determination is satisfied and the routine goes to the subsequent Step S790.

At Step S790, the control circuit 201 registers the tag ID and the case information obtained at Step S750 and the print information prepared at Step S760 in association in the database 203. Then, this routine is finished.

The above Step S730 constitutes a determining portion configured to determine if the produced RFID label described in each claim follows the chronological order of a plurality of work procedures or not.

The flowchart does not limit the present invention to the procedures shown in the flow but is capable of addition/deletion of procedures or change of the order and the like in a range not departing from the gist and technical idea of the invention.

FIG. 10 is a flowchart illustrating a control procedure executed by the control circuit 102 of the apparatus 100 for producing RFID labels.

In FIG. 10, first, at Step S810, the control circuit 102 determines whether or not the tag ID and the print information have been received from the control circuit 201 of the server 200 through the communication line NW (See Step S660 in FIG. 7, Step S770 in FIG. 9). This step is repeated till the tag ID and the print information have been received, and upon receipt, the determination is satisfied and the routine goes to the subsequent Step S820.

At Step S820, the control circuit 102 generates access information by the radio frequency circuit 101 and transmits it to the RFID circuit element To through the device antenna 106 and writes the received tag ID at Step S810 in the IC circuit part 150. Also, print by the print head 105 is made based on the print information received at Step S810.

At the subsequent Step S830, the control circuit 102 produces the RFID label T (main RFID label T or the sub RFID label T) provided with one RFID circuit element To by cutting the tag tape 103 to a predetermined length, on which the print and the information writing in the RFID circuit element To have been finished through driving of the cutter 107.

At the subsequent Step S840, the control circuit 102 transmits a label production completion signal indicating that the production of the RFID label T (main RFID label T or the sub RFID label T) has been completed to the control circuit 201 of the server 200 through the communication line NW. Then, this flowchart is finished.

The above Step S840 constitute a region generation instructing portion configured to output a generation instruction signal for generating storage regions for tag identification information corresponding to the remaining RFID labels in a plurality of the RFID labels in the database in association with the storage region for the tag identification information corresponding to one RFID label in the database when a single RFID label in the plurality of RFID labels described in each claim is to be produced, and the main RFID label production completion signal to be transmitted to the server 200 at Step S840 when the main RFID label T is produced corresponds to the generation instruction signal.

The flowchart does not limit the present invention to the procedures shown in the flow but is capable of addition/deletion of procedures or change of the order and the like in a range not departing from the gist and technical idea of the invention.

FIG. 11 is a top view illustrating an example of an appearance of the RFID label T produced by the above control in the apparatus 100 for producing RFID labels. FIG. 11A illustrates the appearance of the main RFID label T, and FIGS. 11B and 11C for the appearance of the sub RFID label T.

As shown in FIGS. 11A, 11B and 11C, on the surface (upper face) of each RFID label T, usage of the RFID label (“for folder” in the case of the main RFID label T and “for claim” or “for specification” in the case of the sub RFID label T), intellectual property serial number, representative inventor, attorney, and title of the invention are printed. The print items do not have to be limited to them but the print items may be reduced such that only the RFID label usage and the intellectual property serial number are used or further information may be printed. Also, not only characters but figures, symbols, paint or patterns may be added as long as the case can be recognized/identified in some way.

Though not shown in FIG. 11, each RFID label T incorporates the RFID circuit element To constituted by the tag antenna 151 configured to transmit/receive the RFID tag information and the IC circuit part 150 connected thereto and capable of storing the RFID tag information, respectively.

FIG. 12 is a flowchart illustrating a detailed procedure of the progress update processing. As mentioned above, the work processes of each case are constituted by eleven processes of an in-house meeting (process 1), sending of an order (process 2), meeting with a patent attorney's office (process 3), receipt of claims (process 4), claim check by inventor (process 5), intellectual property claim check (process 6), receipt of specification manuscript (process 7), manuscript check by inventor (process 8), intellectual property specification check (process 9), filing (process 10), request for examination (process 11), but in this embodiment, the progress update is carried out by using the main RFID label T for the processes 1 to 4, the sub RFID label T for claim for the processes 5 to 6, the main RFID label T for the process 7, the sub RFID label T for specification manuscript for the processes 8 to 9, and the main RFID label T for the subsequent processes 10 to 11. In the following description of FIG. 12, the type of the RFID labels is not distinguished but described merely as the RFID label T.

First, at Step S210, the control circuit 201 determines if the tag ID has been read out of the RFID label T or not. Specifically, the control circuit 201 transmits a control signal to the control circuit 303 of the PC 300 through the communication line NW and through the radio frequency circuit 402 and the antenna 401 of the reader 400, a reading-out signal for reading the tag ID stored in the IC circuit part 150 of the RFID circuit element To in the RFID label T is transmitted. After that, it is determined if a reply signal replied from the RFID circuit element To corresponding to the reading-out signal is received through the antenna 401 and taken into the control circuit 303 through the radio frequency circuit 402. This step is repeated till the tag ID has been read out and upon reading-out, the determination is satisfied and the routine goes to the subsequent Step S220.

At Step S220, the control circuit 201 receives and obtains through the communication line NW the tag ID obtained by the control circuit 303 of the PC 300 from the RFID label T at Step S210.

At the subsequent Step S230, the control circuit 201 searches the database 203 based on the tag ID obtained at Step S220 and reads out the case information (progress information) of a patent case corresponding to the tag ID.

At the subsequent Step S240, the control circuit 201 transmits a control signal to the control circuit 303 of the PC 300 based on the progress state of the case read out at Step S230 to have the progress update screen corresponding to the subsequent work process be displayed by the display part 301. For example, if the current progress state is that the meeting with a patent attorney's office (process 3) has been finished, the update screen corresponding to the subsequent claim receipt (process 4) is displayed.

At the subsequent Step S250, the control circuit 201 receives update information input by the staff in charge of intellectual property using the operation part 302 of the PC 300 while referring to the update screen through the communication line NW. In the above example, for example, date of claim receipt input by the staff in charge of intellectual property is input in the update screen corresponding to the claim receipt (process 4).

At the subsequent Step S260, the control circuit 201 determines if the progress update is to be carried out or not. The determination is made based on whether or not the control circuit 201 has received an update command signal input by the staff in charge of intellectual property using the operation part 302 of the PC 300 (input by pushing the “update” button displayed on the screen, for example) through the communication line NW. If an update command signal has not been received (update is not to be carried out), the determination is not satisfied and the routine returns to Step S250. On the other hand, if the update command signal has been received (update is to be carried out), the determination is satisfied and the routine goes to the subsequent Step S270.

At Step S270, the control circuit 201 registers the update information input at Step S250 in the database 203 and updates the case information. Then, the routine is finished.

By the above control, with regard to the processes 1 to 4 for which the staff in charge of intellectual property manages works, after the staff in charge of intellectual property updates progress using the main RFID label T and issues the sub RFID label T for claim, by attaching the sub RFID label T to a claim manuscript, an inventor can update the progress from the process 5 to the process 6 using the sub RFID label T attached to the claim manuscript when claim check is finished. Similarly, after the sub RFID label T for specification manuscript is issued, by attaching the sub RFID label T to the specification manuscript, the inventor can update the progress from the process 8 to the process 9 using the sub RFID label T attached to the specification manuscript when the specification check is finished.

The flowchart does not limit the present invention to the procedures shown in the flow but is capable of addition/deletion of procedures or change of the order and the like in a range not departing from the gist and technical idea of the invention.

FIG. 13 is a flowchart illustrating a detailed procedure of the progress list display processing. The progress list display can be displayed regardless of the progress of the case using either of the main RFID label T or the sub RFID label T. Therefore, in the following description on FIG. 13, the type of RFID labels is not distinguished but described merely as the RFID label T.

First, at Step S310, the control circuit 201 determines if the progress state is displayed individually for each case or a plurality of cases is displayed in a list. This determination is made based on whether or not the control circuit 201 has received a list display command signal input by the staff in charge of intellectual property using the operation part 302 of the PC 300 (input by pushing a “list” button displayed on the screen, for example) through the communication line NW. If the list display command signal has been received, the determination is not satisfied and the routine goes to Step S320, where the staff in charge of intellectual property inputs identification information of the staff input by the staff in charge of intellectual property using the operation part 302 of the PC 300 (ID and password of the staff, for example) through the communication line NW. Then, the routine goes to the subsequent Step S350.

On the other hand, if the list display command signal is not received at Step S310 (that is, in the case of individual display), the determination is satisfied and the routine goes to the subsequent Step S330. At Step S330, the control circuit 201 determines if the tag ID has been read out of the RFID label T. This step is repeated till the tag ID has been read out and upon reading-out, the determination is satisfied and the routine goes to the subsequent Step S340.

At Step S340, the control circuit 201 receives and obtains the tag ID obtained by the control circuit 303 of the PC 300 from the RFID label T at Step S330 through the communication line NW.

At the subsequent Step S350, the control circuit 201 searches the database 203 based on the plural or single tag ID obtained at Step S320 or Step S340 and reads out the case information (progress information) of the patent case corresponding to the tag ID.

At the subsequent Step S360, the control circuit 201 transmits the case information (progress information) read out of the database 203 at Step S350 to the control circuit 303 of the PC 300 through the communication line NW. Then, this routine is finished.

The flowchart does not limit the present invention to the procedures shown in the flow but is capable of addition/deletion of procedures or change of the order and the like in a range not departing from the gist and technical idea of the invention. For example, the staff in charge of intellectual property inputs the staff identification information in order to display list (See Step S320), but not limited to that, each work procedure may be started after inputting the staff identification information for login first in the PC 300, for example. In this case, the above Step S320 is not necessary any more.

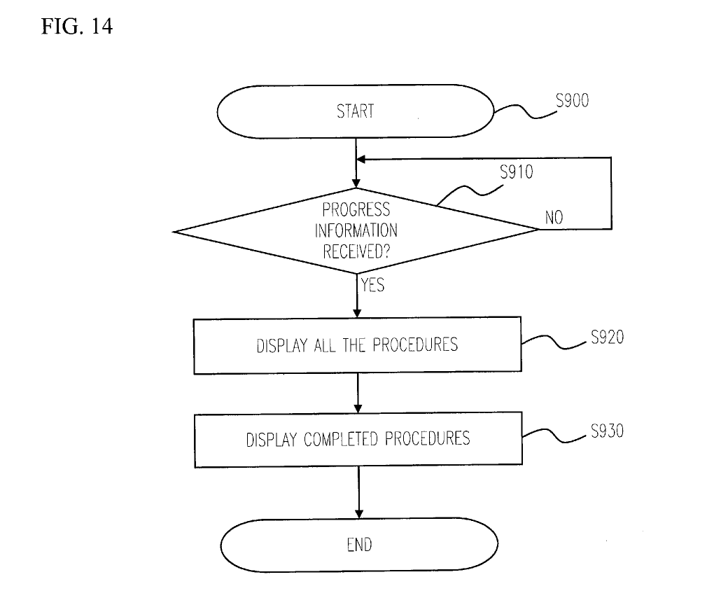

FIG. 14 is a flowchart illustrating a control procedure executed by the control circuit 303 of the PC 300 when the progress list display is made.

First, at Step S910, the control circuit 303 determines whether or not the case information (including progress information) has been received from the control circuit 201 of the server 200 through the communication line NW. At this time, in the case of the list display, the case information on the plurality of cases handled by the staff in charge of intellectual property are all received, while in the case of individual display, single case information corresponding to the RFID label T read out by the reader 400 is received. This step is repeated till the case information is received and upon receipt, the determination is satisfied and the routine goes to the subsequent Step S920.

At Step S920, the control circuit 303 outputs a display signal to the display part 301 based on the received case information and displays a total-procedure display part 310 (See FIG. 15, which will be described later) corresponding to all the processes of the plurality of work processes to be completed (11 processes mentioned above).

At the subsequent Step S930, the control circuit 303 outputs a display signal to the display part 301 based on the received case information and displays a completed-procedure display part 320 corresponding to the work processes having been completed so far in the plurality of work processes (11 processes mentioned above) (See FIG. 15, which will be described later). At this time, in the case of the list display, all case information on the plurality of cases is received, while in the case of individual display, single case information corresponding to the tag ID of the RFID label T (RFID circuit element To) read out by the reader 400 is received. Then, this flow is finished.

The above Step S920 constitutes a display signal output portion for a total procedure configured to output a display signal for displaying the total-procedure display part corresponding to all the procedures of the plurality of work procedures to be completed in each claim, and Step S930 constitutes a display signal output portion for a completed procedure configured to output a display signal for displaying the completed-procedure display part corresponding to the work procedures having been completed so far among the plurality of the work procedures in comparison with the total-procedure display part and also constitutes a skip display control portion configured to output a display control signal for displaying a procedure whose execution by a worker is omitted and skipped to the subsequent procedure among the work procedures having been completed so far in a display mode different from that of the other procedures. Also, an application of the patent case constituted by the above 11 processes corresponds to an event completed by the plurality of work procedures along the chronological order.

The flowchart does not limit the present invention to the procedures shown in the flow but is capable of addition/deletion of procedures or change of the order and the like in a range not departing from the gist and technical idea of the invention. For example, in the above, Step S920 and Step S930 are divided into separate steps but they may be conducted in a single step.

FIG. 15 is a diagram illustrating an example of the progress list display displayed on the display part 301 of the PC 300 by the above control. Here, a case where a plurality of cases is displayed in a list is shown.

In FIG. 15, in this example, there are six patent cases handled by the staff in charge of intellectual property and for each case, a progress graph constituted by intellectual property serial number, title of the invention, representative inventor, progress state, final process date, and the total-procedure display part 310 as well as the completed-procedure display part 320 is displayed, respectively.

In the progress graph, the total-procedure display part 310 constituted by numerals of 1 to 11 representing all the processes relating to the patent case (11 processes) and the completed-procedure display part 320 in which a circle symbol is given to any completed processes in all the processes. That is, in the example shown in this figure, the progress state of the case whose intellectual property serial number is “2007-00027” is a state in which claim check by the staff in charge of intellectual property has been finished and a specification manuscript from a patent attorney's office is now waited for, for example. The process indicated by an arrow “→” in the completed-procedure display part 320 indicates that execution of the work by the staff in charge of intellectual property is omitted and skipped to the subsequent process. That is, in the case with the serial number of “2007-00027”, for example, the meeting with patent attorney's office (process 3) was omitted since an attorney participated in the in-house meeting (process 1), for example.

In the progress graph, as shown in the completed-procedure display part 320, circles in colors different from each other are displayed for plural work processes (processes 1 to 3, processes 4 to 6, processes 7 to 9, and processes 10 to 11, respectively, in this embodiment) (circles are black for the processes 10 to 11, though not shown). By this arrangement, the staff in charge of intellectual property can recognize the progress state while clearly and visually distinguishing the plural work processes from each other.

Display of the circle indicating the completed process or the symbol of “→” indicating skip of processes in the completed-procedure display part 320 is not limited to them, but other display modes may be used. For example, the circle indicating the completed process may be other symbol, character, figure and the like, and the symbol of “→” indicating skip may be in any display mode different from the other processes such as in different color, different character, different line, addition of a symbol and the like.

In the above, different colors are used for plural work processes in the completed-procedure display part 320, but not limited to that, it may be only display modes different from each other such as different character, different line, addition of a symbol and the like. Moreover, different display modes are used for plural work processes in the above, but not limited to that, the display mode may be made different for each case.

FIG. 16 is a flowchart illustrating a detailed procedure of the real search processing. The real search is to search an applicable folder by inputting an intellectual property serial number and carrying the reader 400 and placing it over the plural folders when the staff in charge of intellectual property loses a folder of a desired patent case or the like.

First, at Step S410, the control circuit 201 transmits a control signal to the control circuit 303 of the PC 300 through the communication line NW and displays a serial number input screen on the display part 301.

At the subsequent Step S420, the control circuit 201 determines whether or not the serial number input by the staff in charge of intellectual property using the operation part 302 of the PC 300 while referring to the serial number input screen has been received through the communication line NW. This step is repeated till receipt, and upon receipt, the determination is satisfied and the routine goes to the subsequent Step S430.

At Step S430, the control circuit 201 searches the database 203 based on the intellectual property serial number obtained at Step S420 and reads out the tag ID of the patent case corresponding to the serial number.

At the subsequent Step S440, the control circuit 201 determines whether or not the tag ID has been read out of the RFID label T (here, the main RFID label T. The same applies to the following). This step is repeated till the tag ID has been read out and upon reading-out, the determination is satisfied and the routine goes to the subsequent Step S450.

At Step S450, the control circuit 201 receives and obtains the tag ID obtained by the control circuit 303 of the PC 300 from the RFID label T at Step S440 through the communication line NW.

At the subsequent Step S460, the control circuit 201 determines whether or not the tag ID obtained from the database 203 at Step S430 matches the tag ID obtained from the RFID label T at Step S450. If not matched, the routine returns to Step S440, where it is determined again if the tag ID has been read out or not. On the other hand, if matched, the determination is satisfied and the routine goes to the subsequent Step S470.

At Step S470, the control circuit 201 transmits a control signal to the control circuit 303 of the PC 300 so as to display that the applicable RFID label T has been discovered on the display part 301 (“Applicable case is found” or the like, for example). At this time, sound notification may be made using a speaker, not shown. Then, this flow is finished.

In the above, a case where the main RFID label T is searched using the reader 400 was described as an example, but not limited to that, search of the sub RFID label T may be enabled. By this arrangement, not only a desired case folder but even when a claim or a specification manuscript is lost, the applicable manuscript can be searched by inputting the intellectual property serial number and carrying the reader 400.

The flowchart does not limit the present invention to the procedures shown in the flow but is capable of addition/deletion of procedures or change of the order and the like in a range not departing from the gist and technical idea of the invention.

FIG. 17 is a flowchart illustrating a detailed procedure of the label copy processing. This label copy is performed in order to facilitate reading-out by the reader 400 at the real search and the like by producing copies of the main RFID label T and attaching them at plural spots of a folder in a distributed manner, for example. The label copy can be conducted for any of the main RFID label T and the sub RFID label T. Therefore, in the description of FIG. 17 below, the type of the RFID labels is not distinguished but described merely as the RFID label T.

First, at Step S510, the control circuit 201 determines if the tag ID has been read out of the RFID label T or not. This step is repeated till the tag ID is read out and upon reading-out, the determination is satisfied and the routine goes to the subsequent Step S520.

At Step S520, the control circuit 201 receives and obtains the tag ID obtained by the control circuit 303 of the PC 300 from the RFID label T at Step S510 through the communication line NW.

At the subsequent Step S530, the control circuit 201 searches the database 203 based on the tag ID obtained at Step S520 and reads out the case information and the print information of the patent case corresponding to the tag ID.

At the subsequent Step S540, the control circuit 201 sets the tag ID to be written in the RFID circuit elements To of the plurality of RFID labels T to be produced. This setting is realized by reading out by the control circuit 201 of appropriate IDs from the tag ID database stored in the database 203 as mentioned above. A database for tag ID setting may be provided separately from the database 203.

At the subsequent Step S550, the control circuit 201 transmits the tag ID set at Step S540 and the print information read out of the database 203 at Step S530 to the control circuit 102 of the apparatus 100 for producing RFID labels through the communication line NW.

At Step S560, the control circuit 201 determines whether or not the RFID label production completion signal (See Step S840 in FIG. 10) transmitted from the control circuit 102 when the production of the RFID label T is completed in the apparatus 100 for producing the RFID label has been received through the communication line NW. This step is repeated till the RFID label production completion signal is received, and upon receipt, the determination is satisfied and the routine goes to the subsequent Step S570.

At Step S570, the control circuit 201 registers the tag ID set at Step S540 and the case information and the print information read out of the database 203 in association in the database 203. Then, this routine is finished.

The flowchart does not limit the present invention to the procedures shown in the flow but is capable of addition/deletion of procedures or change of the order and the like in a range not departing from the gist and technical idea of the invention.

In the above, the control circuit 102 of the apparatus 100 for producing RFID labels constitutes a coordination control portion for copy configured to control a feeding device, a printing device and a tag access device in coordination with each other so that a new RFID label in which stored information equivalent to the stored information of the RFID circuit element is written in another RFID circuit element is produced when a radio search device described in each claim searches the RFID circuit element of the main RFID label or the sub RFID label and succeeds in access.

In the embodiment mentioned above, with regard to the application of the patent case completed by the plural work processes along the chronological order, display of the total-procedure display part 310 corresponding to all the processes of the plural work processes is carried out on the display part 301 based on the display signal from the control circuit 303 of the PC 300. Also, likewise, based on the display signal from the control circuit 303 of the PC 300, display of the completed-procedure display part 320 corresponding to the processes having been completed so far among all the processes is carried out on the display part 301 in comparison with the total-procedure display part 310. By this arrangement, since the progress states of the plural work processes can be managed in a centralized manner, the progress state of the patent application case can be grasped easily in stages. Also, the progress state information can be shared easily.

Particularly in this embodiment, the processes whose execution by a worker is omitted and skipped to the subsequent steps among the work processes having been completed so far which are displayed on the completed-procedure display part 320 in the chronological order are displayed in a display mode different from the other processes (arrows in this embodiment). By displaying the skipped process differently from the other processes as above, the skipping can be clearly and visually recognized by the operator and an attention can be surely drawn.

Also, particularly in this embodiment, with regard to the application of the patent case completed by the plural work processes in the chronological order, display of the total-procedure display part 310 corresponding to all the processes of the plural work processes is carried out on the display part 301 based on the display signal from the control circuit 303 of the PC 300. Also, by the display signal from the control circuit 303 of the PC 300 based on the progress information obtained from the RFID label T through radio communication, the display of the completed-procedure display part 320 corresponding to the processes having been completed so far among all the processes is executed on the display part 301 in comparison with the total-procedure display part 310. By this arrangement, by storing the information corresponding to the plural work processes in the RFID label T, the progress states of the plural work processes can be displayed based on the information reading-out with respect to the RFID label T. As a result, the progress state of the patent case can be easily grasped in stages and the progress state information can be easily shared.

Also, particularly in this embodiment, the control circuit 303 of the PC 300 displays the completed-procedure display part 320 on the display part 301 corresponding to the information obtained from the RFID label T (the main RFID label T and the two sub RFID labels T) with which the last communication is made in the progress update processing (that is, corresponding to the progress information updated lastly using the main RFID label T or the sub RFID label T) based on information communication results of the plurality of RFID labels T (main RFID label T and the two sub RFID labels T) provided corresponding to the plural work processes. By preparing the plural RFID labels T corresponding to the plural work processes as above, depending on which of the RFID labels T the information is read out of in the progress update processing, the corresponding work process becomes the latest work currently being conducted, and the latest progress state can be displayed based on that.

Also, particularly in this embodiment, the control circuit 303 of the PC 300 displays a list of the plural completed-procedure display parts 320 corresponding to the plural patent cases, respectively. By this arrangement, the progress state of the plural work processes can be managed in a centralized manner for each of the plural patent cases, and the progress state of each event can be easily grasped in stages.

Also, particularly in this embodiment, the control circuit 303 of the PC 300 displays the completed-procedure display part 320 on the display part 301 so that the plural work processes are in display modes different from each other (in different colors in this embodiment). By this arrangement, each of the plural work processes can be clearly distinguished visually and recognized so that the operator can recognize that.

The present invention is not limited by the above embodiments but is capable of various variations in a range not departing from its gist and technical idea. Such variations will be described below in order.

(1) When the Tag ID Includes Attribute Code:

Though not particularly described in the embodiments, when the main tag ID and the sub tag ID are set when producing the main RFID label T (See Step S640 and Step S690 in FIG. 7), the tag ID may be set so that an attribute code indicating whether it is the main tag ID or the sub tag ID is included, respectively. By providing an attribute code to distinguish between the main tag ID and the sub tag ID as above, whether it is the main RFID label T or the sub RFID label T can be easily distinguished only by identifying only that portion in the tag ID. Also, in the tag ID, parts other than the attribute code can be given in the same standards/modes, by which tag ID management can be simplified/facilitated.

(2) Variation of Progress Graph Display

In the above embodiments, in the progress graph of progress list display made on the display part 301 of the PC 300, the completed-procedure display part 320 indicating the completed processes is constituted by a symbol of a circle, but not limited to that. The display variations will be shown below.

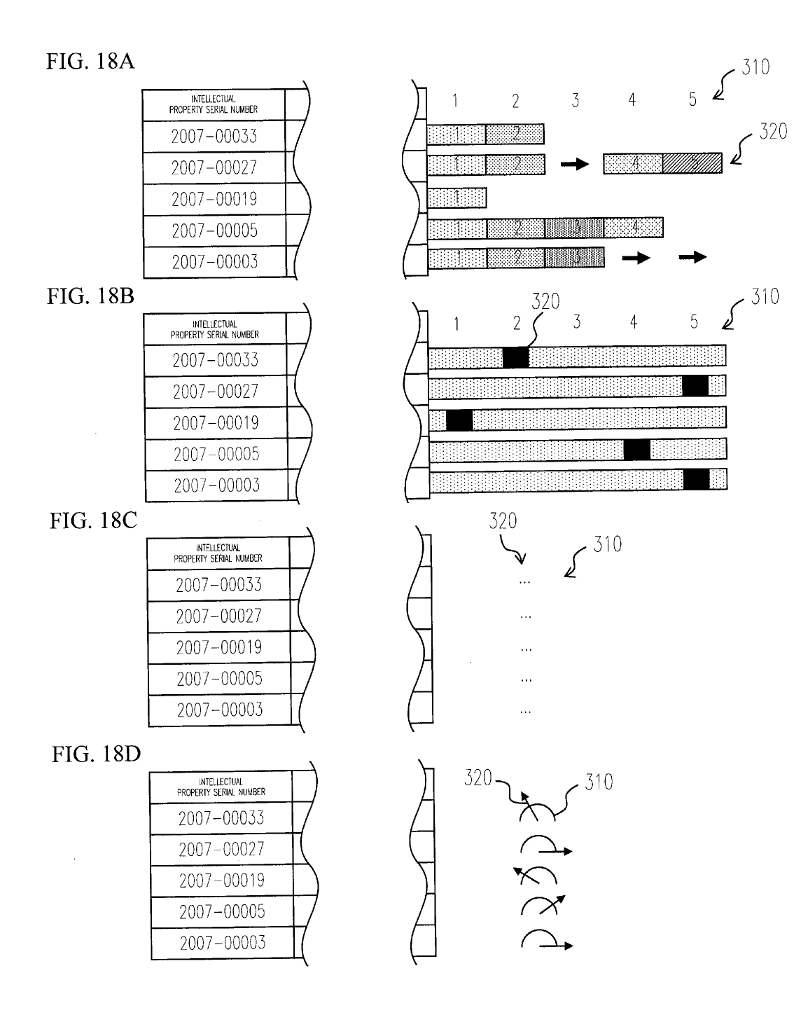

FIG. 18 is a diagram illustrating a variation of a progress graph constituted by the total-procedure display part 310 and the completed-procedure display part 320. In FIG. 18, all the processes of each case are shown as five processes for simplification.

For example, as shown in FIG. 18A, the completed-procedure display part 320 indicating completed processes may be constituted by a drawing substantially in a rectangular shape in which the process number is inserted. Here, the processes are displayed in colors different from each other. The skipped processes are indicated by the arrow “→” similarly to FIG. 15.

Alternatively, as shown in FIG. 18B, the progress state may be represented by sliding of the substantially rectangular completed-procedure display part 320 indicating the process currently in progress within the total-procedure display part 310 substantially in the rectangular shape extended over all the processes, for example.

Alternatively, as shown in FIG. 18C, it may be so configured that the progress state can be recognized by fractions, for example. In this case, the total-procedure display part 310 is a numeral in denominator (including slush) and the completed-procedure display part 320 is a numeral in numerator. Moreover, as shown in FIG. 18D, it may be displayed in the form of a speedometer of an automobile. In this case, the completed-procedure display part 320 substantially in an arrow shape moves as if rotating from the left end to the right end of the substantially semi-circular total-procedure display part 310.

In the above embodiments, deadline of each process is not particularly considered, but among the work processes displayed in the completed-procedure display part 320 which have been completed so far, those having already reached a completion deadline set in advance may be displayed in a display mode different from the other procedures.

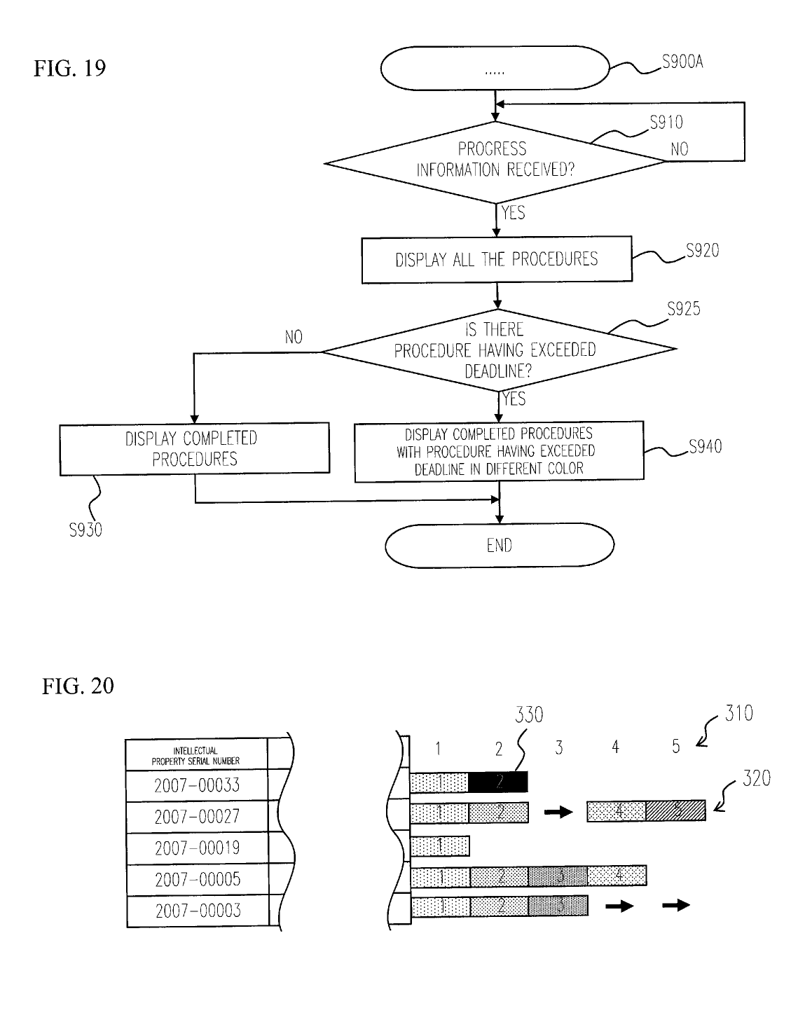

FIG. 19 is a flowchart illustrating a control procedure executed by the control circuit 303 of the PC 300 when the progress list display is made in this variation and corresponds to FIG. 14.

First, at Step S910, the control circuit 303 determines whether or not the case information (including the progress information) has been received from the control circuit 201 of the server 200 through the communication line NW. This case information includes completion deadline information (application deadline and the like) set in advance for each work process. This step is repeated till the case information is received, and upon receipt, the determination is satisfied and the routine goes to the subsequent Step S920.

At Step S920, the control circuit 303 outputs a display signal to the display part 301 based on the case information received and display the total-procedure display part 310 corresponding to all the processes of the plurality of work processes to be completed.

At the subsequent Step S925, the control circuit 303 compares the progress information of the patent case and the completion deadline information received at Step S910 and determines if there is a process having exceeded the completion deadline or not. If there is no process having exceeded the deadline, the determination is not satisfied, the routine goes to Step S930, and the control circuit 303 outputs a display signal to the display part 301 based on the received case information and displays the completed-procedure display part 320 corresponding to the work processes having been completed so far among the plural work processes. Then, this flow is finished.

On the other hand, if there is a process having exceeded the deadline at Step S925, the determination is satisfied and the routine goes to Step S940. At Step S940, the control circuit 303 outputs a display signal to the display part 301 based on the received case information so that the process having exceeded the completion deadline is displayed in a display mode different from the other processes (different color, different character, different line, addition of symbol or the like) and displays the completed-procedure display part 320 corresponding to the work process having completed so far among the plural work processes. Then, the flow is finished.

The above Step S925 constitutes a display control portion for deadline management configured to output a display control signal for displaying those having already reached the completion deadline set in advance in a display mode different from the other procedures in the work procedures completed so far displayed on the completed-procedure display part described in each claim.

The flowchart does not limit the present invention to the procedures shown in the flow but is capable of addition/deletion of procedures or change of the order and the like in a range not departing from the gist and technical idea of the invention.

FIG. 20 is a diagram illustrating an example of the progress list display displayed by the above control on the display part 301 of the PC 300. In this example, order sending (process 2) of the case with the intellectual property serial number “2007-00033” has already exceeded its completion deadline and thus, a display part 330 corresponding to the process 2 of this case in the completed-procedure display part 320 is displayed in a display mode different from the other processes (black-and-white reversed in this example).

According to the variation described as above, by displaying those having exceeded the deadline in a mode different from the others, the staff in charge of intellectual property can clearly and visually recognize it, and attention can be surely drawn.

Though not particularly described in the above embodiments, it may be so configured that those corresponding to selection instruction input by an operator are extracted for selective display from the patent progress list display displayed on the display part 301 of the PC 300.

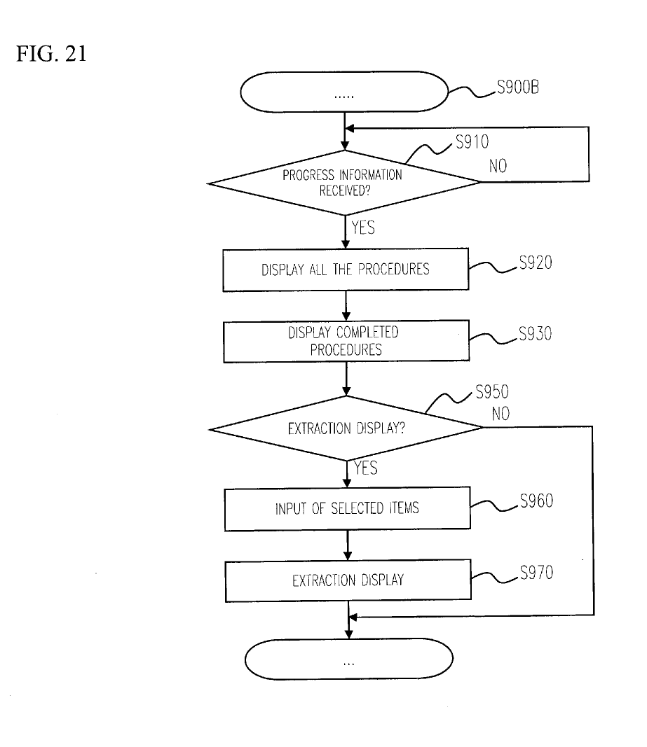

FIG. 21 is a flowchart illustrating a control procedure executed by the control circuit 303 of the PC 300 when the progress list is displayed in this variation and corresponds to FIG. 14 and the like.

Since Step S910 to Step S930 are the same as FIG. 14, the description will be omitted.

At the subsequent Step S950, the control circuit 303 determines if the progress list display is extracted and displayed or not. This determination is made based on whether or not the control circuit 303 has received a selection instruction input signal input by the operator using the operation part 302 of the PC 300 (input by pushing an “extraction display” button displayed on the screen, for example). If the selection instruction input signal has not been received, this flow is finished. On the other hand, if the signal has been received, the determination is satisfied and the routine goes to the subsequent Step S960, where selection instruction information input by the operator using the operation part 302 of the PC 300 (a case handled by himself, a case having progressed to a predetermined process and the like, for example) is input. Then, the routine goes to the subsequent Step S970.

At Step S970, the control circuit 303 outputs a display signal to the display part 301 based on the selection instruction information input at Step S960 and selectively displays the patent progress list. Then, this flow is finished.

The above Step S970 constitutes an extracting display control portion configured to output a display control signal for extracting those corresponding to the selection instruction input by the operator for selective display in displays of the total-procedure display part or the completed-procedure display part described in each claim.

The flowchart does not limit the present invention to the procedures shown in the flow but is capable of addition/deletion of procedures or change of the order and the like in a range not departing from the gist and technical idea of the invention.

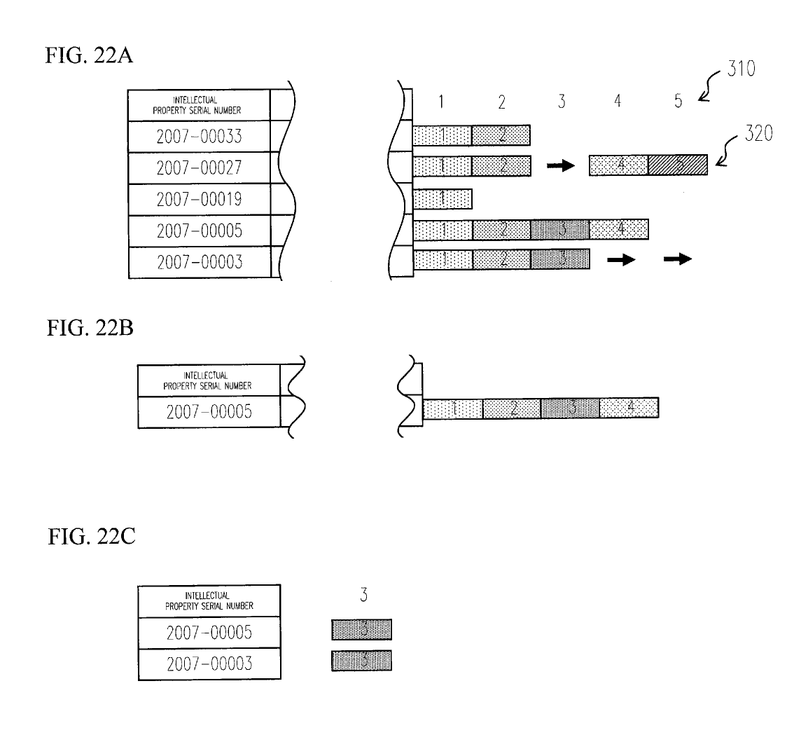

FIG. 22 is a diagram illustrating an example of extraction of the progress list display executed by the above control. In FIG. 22, FIG. 22A shows an example of the progress list display before the extraction display, FIG. 22B shows an example of display obtained by selecting and extracting the intellectual property serial number “2007-00005” from the progress list display state shown in FIG. 22A, and FIG. 22C shows an example of display obtained by selecting and extracting a case finished with the meeting with a patent attorney's office (process 3) from the progress list display state shown in FIG. 22A.

According to the variation described above, since the case or work process and the like according to an intention of the operator can be picked up and displayed in a state excess display is removed, convenience can be improved.

(3) Others

In the above embodiments, an example in which the sub RFID label T was produced when each case has progressed to the claim receipt (process 4) and the specification manuscript receipt (process 7) in all the 11 processes was used as an example, but not limited to that. For example, the sub RFID label T may be produced for each process.

In the above embodiments, the number of work processes was 11, but not limited to that, and items may be replaced, added or the like as appropriate. For example, the claim and the specification manuscript are separately received from the patent attorney's office in the above, but they may be received in a lump sum as a patent specification. Also, for example, the work process is set up to the request for examination, but the subsequent processes such as notification of reasons for refusal, filing of written opinion or amendment, request for appeal against decision of refusal and the like may be added.

In the above, an example in which the PC 300 as a progress display unit is applied to the patent progress management system configured to manage progress of the patent cases was used for explanation, but not limited to that. That is, it can be applied to other systems as long as the system is configured to manage progress states of an event completed by a plurality of work procedures such as processing management of various approval documents, progress management from procurement to disposal of fixed assets (estimates, applications, slips invoices, receipt and inspection, request for disposal and the like), management of plural workflows in a project, process management in a construction site and the like, for example.

Also, in the above, radio communication performed between the RFID circuit element To of the RFID label T and the antenna 401 of the reader 400 was not particularly described, but information may be transmitted/received by radio communication using an UHF band, for example, or information may be transmitted/received by magnetic induction using an HF band (including electromagnetic induction, magnetic coupling, and other non-contact manner executed through electromagnetic field) using a coil-state loop antenna as the antenna 401 of the reader 400 and the tag antenna 151 on the side of the RFID circuit element To.

In the above, the case in which the tag tape 103 finished with the print and access (writing) to the RFID circuit element To is cut with the cutter 107 so as to produce the RFID label T has been described as an example, but not limited to that. That is, if a label board (so-called die-cut label) separated in advance to a predetermined size corresponding to the label is continuously arranged on the tape fed out of the roll, the tape is not cut with the cutter 107 but after the tag tape 103 is discharged out of a carry-out exit, only the label board (those provided with the accessed RFID circuit element To and having the corresponding print applied) may be peeled off the tape so as to produce the RFID label T, and the present invention can be also applied to such tapes.

Moreover, in the above, an example in which the tag tape 103 is wound around a reel member so as to constitute the roll of tape 104 with RFID tag (or a cartridge provided with the roll of tape 104 with RFID tag) and the tag tape 103 is fed out of this roll 104 was described but not limited to that. For example, a lengthy flat-sheet state or strip-state tape or sheet (including those formed by cutting a tape wound around a roll is fed out and then, cut into an appropriate length) on which at least one RFID circuit element To is arranged is stacked in a predetermined storage part (flatly laminated in a tray-like container, for example) to be made into a cartridge, and this cartridge is attached to a cartridge holder on the side of the apparatus for producing RFID labels so that the tape is transferred and transported from the storage part and printed and written so as to produce the RFID label T.

Moreover, there may be configuration that the roll is directly and detachably attached to the side of the apparatus for producing RFID labels or configuration that the lengthy flat-sheet state or strip state tape or sheet is transferred from outside the apparatus for producing RFID labels one by one by a predetermined feeder mechanism and supplied into the apparatus for producing RFID labels. Moreover, not limited to those detachably attached to the side of the apparatus body for producing RFID labels such as the roll of tape 104 with RFID tag (or the cartridge provided therewith), the roll of tape 104 with RFID tag may be provided on the side of the apparatus body in a so-called installed or integrated type not capable of detachment. In this case, too, the same effect is obtained.

Also, in the above, a method of direct print on the tag tape (so-called non-laminate type) is employed, but not limited to that, the present invention may be applied to a method in which print is made on a cover film (print-receiving medium) separate from the tag tape 103 provided with the RFID circuit element To and they are bonded together (so-called laminate type).

Other than those mentioned above, methods of the embodiments and their variations may be combined as appropriate for use.

Though not specifically exemplified, the present invention should be put into practice with various changes made in a range not departing from its gist.

What is claimed is:

1. A progress display apparatus displaying a progress state of an event to be completed by a plurality of work procedures along a chronological order, comprising:
a display signal output portion for a total procedure configured to output a display signal for displaying a total-procedure display part corresponding to all the procedures of said plurality of work procedures to be completed; and
a display signal output portion for a completed procedure configured to output a display signal for displaying a completed-procedure display part corresponding to at least one work procedure having been completed so far among said plurality of work procedures in comparison with said total-procedure display part.

2. The progress display apparatus according to claim 1, further comprising a display control portion for deadline management configured to output a display control signal for displaying at least one work procedure in a display mode different from that of the other procedures among said work procedures completed so far displayed on said completed-procedure display part, said at least one work procedure having completion deadlines that is set in advance and has been already reached.

3. The progress display apparatus according to claim 1, further comprising a display control portion for a skip configured to output a display control signal for displaying at least one work procedure in a display mode different from that of the other procedures among said work procedures completed so far displayed on said completed-procedure display part along the chronological order, the execution of said at least one work procedure by a worker being omitted and skipped to the subsequent procedure.

4. The progress display apparatus according to claim 1, wherein:
said display signal output portion for a completed procedure outputs corresponding said display signal based on information obtained from a RFID tag through radio communication.

5. The progress display apparatus according to claim 4, wherein:
said display signal output portion for a completed procedure outputs said display signal corresponding to the information obtained from said RFID tag for which the last communication was made based on an information communication result with a plurality of said RFID tags provided corresponding to each of said plurality of work procedures.

6. The progress display apparatus according to claim 4, wherein:
said display signal output portion for a completed procedure outputs said display signal for displaying in a list a plurality of said completed-procedure display parts corresponding to each of a plurality of said events.

7. The progress display apparatus according to claim 6, wherein:
said display signal output portion for a total procedure or said display signal output portion for a completed procedure outputs a display signal for displaying said total-procedure display part or said completed-procedure display part in display modes different from each other for each of said plurality of events or each of said plurality of work procedures.

8. The progress display apparatus according to claim 4, further comprising a display control portion for an extraction configured to output a display control signal for extracting and selectively indicating at least one display among displays indicated in said total-procedure display part or said completed-procedure display part according to a selection instruction input by an operator.

9. A progress management system comprising:
a reading apparatus configured to read out information through radio communication from RFID tags corresponding to a plurality of work procedures for preparing a patent application specification to be completed by said plurality of work procedures along a chronological order; and
a progress display apparatus configured to display in comparison a total-procedure display part corresponding to all the procedures of said plurality of work procedures to be completed and a completed-procedure display part corresponding to the work procedure having been completed so far among said plurality of work procedures, based on the information obtained by said reading apparatus from said RFID tag through the radio communication.

10. The progress management system according to claim 9, wherein:
said progress display apparatus makes display corresponding to the information obtained from said RFID tag for which the last communication was made based on an information read-out result by said reading apparatus with respect to a plurality of said RFID tags provided corresponding to each of said plurality of work procedures.
